(19) United States
(12) Patent Application Publication
(10) Pub. No.: US 2013/0000427 A1
(43) Pub. Date: Jan. 3, 2013

(54) RISING CABLE WITH STABILIZED DRIVER

(75) Inventor: Klaus Stenzel, Berlin (DE)

(73) Assignee: GEMO D. G. MORITZ GMBH & CO. KG, Berlin (DE)

(21) Appl. No.: 13/579,710

(22) PCT Filed: Feb. 10, 2011
(86) PCT No.: PCT/EP2011/000626

§ 371 Date: Sep. 19, 2012

(30) Foreign Application Priority Data
Feb. 17, 2010 (DE) 10 2010 008 365.8

(51) Int. Cl. F16H 19/04

(52) U.S. Cl. 74/30

(57) ABSTRACT

In a rising cable (1) with a driver (5) which is fastened at its one end and is configured for coupling to a sliding element (17) which can be moved in the axial direction of the rising cable (1), the driver (5) is configured as a cast metal body which is cast around the end region of the rising cable (1), and said driver (5) has a lateral recess (16) which is configured for coupling and is arranged in the axial direction on the other side of the end of the rising cable (1), wherein an axially parallel pin (10) is cast integrally in that cross section of the driver (5) which remains next to the recess (16).

### BACKGROUND OF INVENTION

1. Field of Invention

The invention concerns a rising cable with a driver.

2. Description of Related Art

A rising cable exhibits a flexible core, which is usually constructed in many layers out of counterwound wires. Around the core is a coil made of wire wound in rigid compression and actually with a considerable thread distance between the windings. A driver serves for coupling to a driven element.

Important areas of application are drives for the sliding roofs of vehicles and similar uses such as, for example, a drive for light-protection shades in vehicles.

In these applications, a sliding element, thus, for example, a movable sliding roof, is coupled on both sides to one driver each of a rising cable. The rising cable runs around the section of the sliding roof to a common drive, where it is with the gear wheel in gear, which meshes in the winding pitch of the rising cable, and this operates like a rack.

As a result, the construction of the driver, which must transfer high forces, is difficult in cost-effective mass production. Known drivers for rising cables are either made of metal and crimped on by cold working or they are made of plastic, which are cast in a spray-casting process around the end area of the rising cable. In both cases, the strength results are not satisfactory, in which, with plastic, the low material load capacity is particularly disturbing.

Drivers, which, in the usual type of construction, exhibit coupling linkages projecting laterally from the rising cable, have enough room in the main body surrounding the rising cable to allow the core of the rising cable to run over the full length through the main body, so that this causes reinforcement of the drivers. If the driver, however, exhibits a lateral recess for coupling, then this also forms a weakening of the drivers and a narrowing of the cross-section, so that the core of the rising cable cannot run through the longitudinal area of the lateral recess. Therefore, only cast material remains here in the driver cross-section beside the recess, which may be prone to breaking under high force.

Known from each of DE 29 12 666 A1, DE 10 2006 021 650 A1, and U.S. Pat. No. 4,038,881 A is a rising cable with a driver fastened at one of its ends, which is designed for coupling to a sliding element movable in the axial direction of the rising cable, in which the driver is designed as a body cast or spray-cast around the end area of the rising cable, and exhibits a lateral recess or enlargement designed for coupling, which is disposed in the axial direction beyond the end of the rising cable. There exists in this prior art the disadvantage discussed in a preceding paragraph of the danger of breaking under high forces.

### BRIEF SUMMARY OF THE INVENTION

The task of the present invention consists of improving the rising cable with respect to costs and the stability of the driver.

This task is achieved with a rising cable with a driver fastened at one of its ends, which is designed for coupling to a sliding element movable in the axial direction of the rising cable, in which the driver is designed as a metal-cast body cast around the end area of the rising cable and exhibits a lateral recess designed for coupling, which is disposed in the axial direction beyond the end of the rising cable, in which an axiparallel bolt is cast in the cross-section of the driver remaining beside the recess.

According to the invention, the driver is designed as a metal-cast body. A metal casting is a reliable casting technique and shows fundamentally higher strength than for a plastic spray-cast body or a crimped-on sheet-metal part, for instance. A further advantage is the fact that the metal casting occurs at higher temperatures, at which plastic materials have already melted. In casting, any possible interfering plastic part on the rising cable, such as, for example, flocked-yarn thread between coil windings, do not need to be removed prior to the casting. The weakened area next to the recess is provided with an embedded axiparallel bolt, which serves as reinforcement and can be constructed in a manner suitable for this, for example, of steel. For better connection and transfer of forces with the cast material, the bolt can be provided, for example, with grooved surfaces.

An additional problem is the drive of a sliding element of two sides here with rising cables that have a certain drive-play in the gear-wheel mesh. Consequently, one side of the sliding element is already moving somewhat farther than the other. These insignificant differences in the millimeter range can, however, quite trouble the eye of the observer, particularly in high-priced limousines. Hence, it is advantageous to fasten to the driver a spring projecting over it, which is eminently suitable for eliminating the oblique-position problem. The sliding-roof drive can be constructed so that, at the end position, both of the rising cables hit with the driver at the end at points on the coachwork. When running up against the detent, the springs yield somewhat and consequently allow the side running behind to still be able to follow the side running somewhat ahead until the sliding roof is straight. This result is attained with a simple construction on the outside, which is superior to highly complicated clearance alignment constructions. The spring can be fastened onto the driver in different ways, for example by screwing it on or the like. It is advantageously fastened, however, by being recast, which further simplifies the construction and cost is reduced.

The end area of the rising cable to be cast is to be inserted into the form needed for the metal casting, as well as the area of the spring to be cast. Advantageously, the spring, however, is put on at a free end-area of the rising-cable core and can be pre-mounted there, so that the insertion process in the pressure-cast form and consequently the end of the procedure is accelerated and cost is reduced.

To manufacture the metal-cast body, various suitable techniques can be used, such as, for instance, metal spraying of plastic blanks, sintering, or metal-powder spray-casting. Advantageously, however, the zinc pressure-casting technique is used, which, especially for large-scale series production, as is necessary in automobile construction, is very well suited for lower costs.

### BRIEF DESCRIPTION OF THE DRAWINGS

In the drawings, the invention is schematically represented by way of example. They show:

FIG. 1 a side view of the end area of a rising cable with driver and spring, and

FIG. 2 in a representation corresponding to FIG. 1 an execution variant.

### DETAILED DESCRIPTION OF THE INVENTION

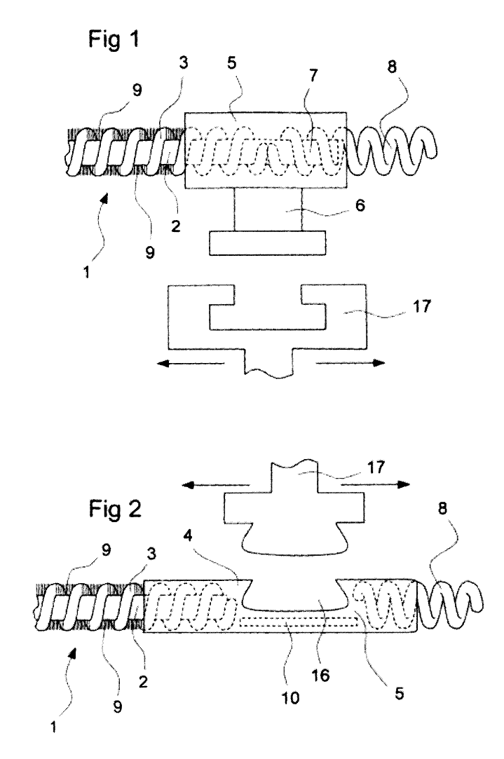

FIG. 1 shows a rising cable 1 with a flexible core 2, which is formed, for example, from wires counterwound in many layers. On the core 2 is a coil 3 made of suitable thicker wire tightly wound up. The rising cable thus designed can be used as a rack; however it has in addition a round cross-section and is bendable.

In the end area of the rising cable 1 depicted by dashes, this is embedded in a driver 5, which is designed as a zinc pressure-cast body. Laterally projecting from the driver 5, a coupling linkage 6 is constructed, which is intended for lateral form-fit operation on a sliding element 17 of a sliding roof, not depicted.

In the end area depicted of the rising cable 1, the coil 3 is removed. At the free end-area 7 of the core 2, a spring 8 is put on, which is cast in the main body 4 of the driver 5.

As FIG. 1 shows, the rising cable 1 outside the drivers 5 between the windings of the coil 3 is flocked with tiny hairs 9. These can, for example, be disposed by winding on flocked-yarn threads there. They serve to damp noise when the rising cable 1 moves in its guide track, not depicted in the figure.

In the manufacture of the construction represented in FIG. 1, starting with an endless rising , this can be cross-cut and then freed at the free end-area 7 of the piece of the coil 3 there. Then the pre-made spring 8 is put on. In this configuration, the insertion can occur into the form required for the manufacture of the pressure casting, so that only the construction group described and previously put together has to be inserted and the insertion of separate parts is avoided.

The tiny hairs 9 can be removed from the rising cable 1 in the end area to be recast. They can, however, also remain on the rising cable, because at the high temperatures of the zinc spray-casting used they are melted away without interference.

FIG. 2 shows an execution variant in which the same reference numbers are used, insofar as possible.

Outside from the drivers 5, the rising cable 1 corresponds fully to the construction of FIG. 1. The driver 5 is in turn cast onto the end area of the rising cable 1 as a zinc spray-cast body. However no lateral coupling linkage 6 according to FIG. 1 is provided to couple the drivers. In the case of the embodiment of FIG. 2, there is a lateral recess 16 designed for meshing with a driver 17, which weakens the cross-section of the cast body 7 at this location. Because the cast body is greatly reduced in cross-section at the location of the lateral recess 16, the rising cable 1 can only be cast in the longitudinal areas up to the recess 16.

The spring 8 is cast into the body 7 like in the embodiment of FIG. 1 but first in the area on the other side of the recess 16.

The remaining cross-section of the drivers 5 next to the recess 16 is prone to breaking. In order to avoid problems here, a bolt 10 is cast into the driver 5, which, for example, can be designed as a steel bolt, and it provides sufficient strength for the driver 5 in this weak area. The bolt 10 can be suitably shaped for better linking with the surrounding recast material or can have a structured surface, for example designed as a threaded rod.

A preferred use area of the constructions depicted is a sliding-roof drive, not depicted, for personal automobiles. At the front cross-edge of the roof section receiving the sliding roof is disposed a electric motor, which, with a gear wheel, drives two rising cables mating with the gear wheel according to the invention, which runs long from there to the two sides of the sliding roof parallel to the edge of the section and, with its drivers 5, are coupled on the right and left to the sliding roof.

The driver 5 runs in the end position of the movement of the sliding roof against a coachwork detent. Because the gear-wheel drive is in somewhat different clearance operation on the two sides of the rising cables, one side of the sliding roof reaches the detent sooner than the other one. The difference is in the range of millimeters, but it can be a problem.

In the constructions depicted in FIGS. 1 and 2, the spring 8 of the respective driver 5 is disposed projecting, such that it runs up against the detent. One of the two drivers runs first up against the detent. Its spring 8 feathers and allows the other driver to still be able to also run ahead somewhat until the sliding roof is straight again.

The spring 8 can also be designed otherwise than in the example depicted, with other wire strengths and a pitch other than the coil 3 and also be wound in the same direction as said coil.

The spring 8 can also be omitted.

1. A rising cable having an end area to which is fastened a driver for coupling to a sliding element movable in an axial direction of the rising cable wherein the driver is a metal-cast body cast around the end area of the rising cable, wherein a lateral recess is provided in the driver for coupling to the sliding element, wherein the lateral recess is disposed in the axial direction beyond the end area of the rising cable and wherein an axiparallel bolt is cast in a cross-section of the driver remaining beside the recess.

2. The rising cable according to claim 1, wherein a spring is fastened to the driver by recasting, the spring yielding at the end-stop of movement and projecting over said driver in the direction of movement.

3. (canceled)

4. The rising cable according to claim 1, wherein the metal-casting body is designed as a zinc pressure-casting body.

5. The rising cable according to claim 2, wherein the metal-casting body is a zinc pressure-casting body.
